(19) United States
(12) Patent Application Publication
(10) Pub. No.: US 2008/0045209 A1
(43) Pub. Date: Feb. 21, 2008

(54) METHOD AND SYSTEM FOR IMPLEMENTING MULTIMEDIA RING BACK TONE SERVICE

(75) Inventors: Xiaojun MO, Shenzhen (CN); Lin LIN, Shenzhen (CN); Kefeng WANG, Shenzhen (CN)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: HUAWEI TECHNOLOGIES CO., LTD., Shenzhen (CN)

(21) Appl. No.: 11/833,797

(22) Filed: Aug. 3, 2007

Related U.S. Application Data
(63) Continuation of application No. PCT/CN2006/001819, filed on Jul. 24, 2006.

(30) Foreign Application Priority Data
Jul. 22, 2005 (CN) 200510085330.6

(51) Int. Cl. H04Q 7/20

(52) U.S. Cl. 455/433

(57) ABSTRACT

A method for implementing a multimedia RBT service includes: receiving, by an calling MSC server, a call request from a calling party; performing a first media capability negotiation between a calling party and an MRS, after detecting a response of a called party; and instructing the MRS to play a multimedia RBT to the calling party according to a result of the first media capability negotiation. A system for implementing the multimedia RBT includes: an MSC server and an MRS. In accordance with embodiments of the invention, a multimedia RBT service may be implemented in the 3G network, thereby enabling an original audio RBT service in a hybrid 3/2G network and the 3G network to coexist with the multimedia RBT service, and ensuring the normal use of an RBT service.

This application is a continuation of International Patent Application No. PCT/CN2006/001819, filed Jul. 24, 2006, which claims priority to Chinese Patent Application No. 200510085330.6, filed Jul. 22, 2005, all of which are hereby incorporated by reference.

### FIELD OF THE INVENTION

The present invention relates to ring back tone (RBT) technologies, and more particularly to a method and system for implementing a multimedia RBT service.

### BACKGROUND OF THE INVENTION

An individualized RBT service has emerged in the Global System for Mobile Communications (GSM). RBT service refers to a service for playing various rings to a calling party according to the customization of a called party. The rings include various audio files, e.g., music, songs, stories and dialogues. When the calling party initiates a call, a ring customized by the called party is played to the calling party before the called party picks up the phone. A ring corresponding to a calling number may further be played to the calling party according to the corresponding relationship between the calling number and the ring customized by the called party. Thanks to the RBT service, the calling party will no longer have to hear monotonous beeps before the called party answers the call, which fully displays the more and more advocated individualized services.

Using a soft switch as its control core and a packet switching network as its transmission network, the 3Frd Generation network (3G) following R99 is a comprehensive and completely open network platform system capable of simultaneously providing a variety of services, e.g., voice, data and multimedia. However, the 3G network capable of providing multimedia services may only provide audio RBT services for the time being, and no specific solution is put forward for implementing a multimedia RBT by making use of the feature of the 3G network. For example, multimedia videos may not, in place of an ordinary RBT, be played to a calling party when a 3G network user males a video call. This is a great pity for the 3G network capable of providing a variety of services.

### SUMMARY OF THE INVENTION

Some embodiments of the present invention provide a method and a system for implementing a multimedia RBT service so as to implement a multimedia RBT service in the 3G network.

The technical solution in accordance with the embodiments of the present invention is implemented as follows.

A method for implementing a multimedia Ring Back Tone (RBT) Service includes:

receiving a call request from a calling party;

performing a first media capability negotiation between the calling party and a Media Resource Server (MRS) after detecting a response of a called party; and

instructing the MRS to play a multimedia RBT to the calling party according to a result of the first media capability negotiation.

The method further includes:

determining, by a calling Mobile Switching Center (MSC) server, that the called party has subscribed to a multimedia RBT service according to subscription information of the called party.

The subscription information of the called party is stored in a Home Location Register (HLR); and

the process of determining that the called party has subscribed to the multimedia RBT service includes:

determining, by the HLR, that the called party has subscribed to an audio RBT service or the multimedia RBT service after determining that the called party has subscribed to a RBT service;

sending to the calling MSC server the subscription information indicating whether the called party has subscribed to the audio RBT service or the multimedia RBT service; and

determining, by the calling MSC server, that the called party has subscribed to the multimedia RBT service according to the subscription information provided by the HLR.

The subscription information of the called party is stored in an HLR, and the method further includes:

providing, by the HLR, the subscription information of the called party for the calling MSC server after determining that the called party has subscribed to an RBT service;

instructing the MRS to play an audio RBT to the calling party according to the subscription information of the called party.

A system for implementing a multimedia Ring Back Tone (RBT) service includes:

a Mobile Switching Center (MSC) server and a Media Resource Server (MRS); and

the MSC server is capable of performing a media capability negotiation between a calling party and the MRS according to a call request from the calling party, and instructing the MRS to play a multimedia RBT to the calling party according to a result of the first media capability negotiation; and

the MRS is capable of storing a multimedia RBT, and performing the media capability negotiation with the MSC server, and playing the multimedia RBT to the calling party according to the result of the first media capability negotiation.

A Media Resource Server (MRS) includes:

a component, configured to:

store a multimedia Ring Back Tone (RBT);

perform a media capability negotiation with a Mobile Switching Center (MSC) server;

play a multimedia RBT according to a result of media capability negotiation for the calling party.

A Mobile Switching Center (MSC) server includes:

a component, configured to:

perform a media capability negotiation with a Media Resource Server (MRS);

perform a media capability negotiation with a subscriber;

instruct the MRS to play a multimedia Ring Back Tone (RBT) according to the media capability negotiation.

In accordance with the solution put forward by some embodiments of the present invention, a multimedia RBT service may be implemented in a 3G network; moreover, the embodiments of the present invention enable original audio RBT services in a hybrid 3/2G network and the 3G network to coexist with the multimedia RBT services, thus ensuring the implementation of the multimedia RBT services. In some embodiments of the present invention, a Media Resource Server (MRS) may determine whether to play a multimedia RBT to a calling party according to the current media capability of the calling party; if the media capability of the calling party supports the multimedia RBT, the MRS shall play the multimedia RBT to the calling party; if the media capability of the calling party does not support the multimedia RBT, the MRS may play an audio RBT to the calling party, thus enabling a multimedia RBT service to coexist with an audio RBT service in the existing 3G network.

In addition, in accordance with other embodiments of the present invention, even though a called party who has subscribed to a multimedia RBT service is a user in the 2G network, as long as the calling party initiating a call to the called party is the user in the 3G network, the multimedia RBT service may still be implemented and the calling party may receive the multimedia RBT played thereto.

Moreover, in accordance with other embodiments of the present invention, when the calling party does not support a second media capability negotiation, the calling MSC server may perform a media capability negotiation with the called party according to the media capability of the calling party, thus providing a flexible manner for the media capability negotiation; in this way, even though a variety of media format standards appear due to the implementation of multimedia RBT services during a call, there will be no impact on the ordinary communication between the calling party and the called party.

### BRIEF DESCRIPTION OF THE DRAWINGS

FIG. 1 is a schematic drawing illustrating the structure of a system for implementing a multimedia RBT service in accordance with an embodiment of the present invention.

FIG. 2 is a flowchart illustrating a procedure for implementing a multimedia RBT service in accordance with another embodiment of the present invention.

FIG. 3 is a flowchart illustrating message interaction for implementing a multimedia RBT service in accordance with another embodiment of the present invention.

### EMBODIMENT OF THE INVENTION

Embodiments are hereinafter described in details with reference to the accompanying drawings to further clarify the technical scheme and advantages of the present invention.

A multimedia RBT service refers to a service for playing various multimedia files customized by a called party to a calling party, and the multimedia files maybe include segments of films or cartoons favored by a called party, photos self-taken by the called party, segments of multimedia made by the called party himself, commercial advertisements, etc.

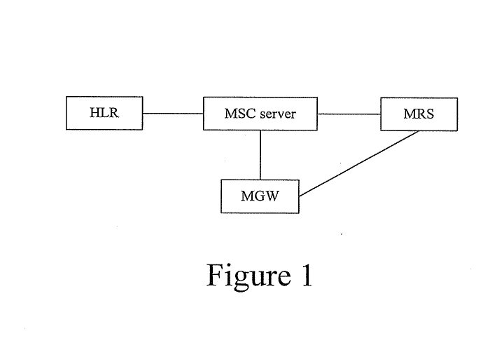

FIG. 1 is a schematic drawing illustrating the structure of a system for implementing a multimedia RBT service in accordance with an embodiment of the present invention. As shown in FIG. 1, the system for implementing the multimedia RBT service includes: a Home Location Register (HLR), a Mobile Switching Center (MSC) server, an MRS and a Media Gateway (MGW). The MSC server is connected to the HLR, the MGW and the MRS respectively, and the MRS is connected to the MGW. The HLR is used for storing user subscription information, and providing the user subscription information for the MSC server. The MSC server is used for controlling a call procedure, controlling the MRS to play a multimedia RBT to a calling party, and controlling the MGW to perform the interaction of media information in the call procedure. The MGW is used for performing the interaction of media information in the call procedure according to the control of the MSC server. The MRS supports a multimedia format, and is used for storing a multimedia RBT and playing the multimedia RBT to the calling party according to the control of the MSC server and the result of media capability negotiation.

An MSC server may control the call procedure through call signaling of Radio Access Network (RAN) and information acquired by communicating with the HLR. The call procedure includes initiating a call, connecting a call, and other processes. The MSC server may control the MGW to perform the interaction of media information in the call procedure via the H.248 protocol, the Media Gateway Control Protocol (MGCP), etc.

When there are both audio RBT services and multimedia RBT services, the system for implementing a multimedia RBT service further includes: an audio resource server supporting an audio format, used for storing an audio RBT and playing the audio RBT to the calling party according to the control of the MSC server. The HLR is further used for determining whether the user has subscribed to an audio RBT service or a multimedia RBT service, or determining that the user has subscribed no RBT service, and providing the MSC server with the determined user subscription information. The audio resource server and the MRS may be disposed in the same device. The audio RBT includes, for example, various Color Ring Back Tones (CRBTs), but is not limited to, music, songs, stories, dialogues, etc.

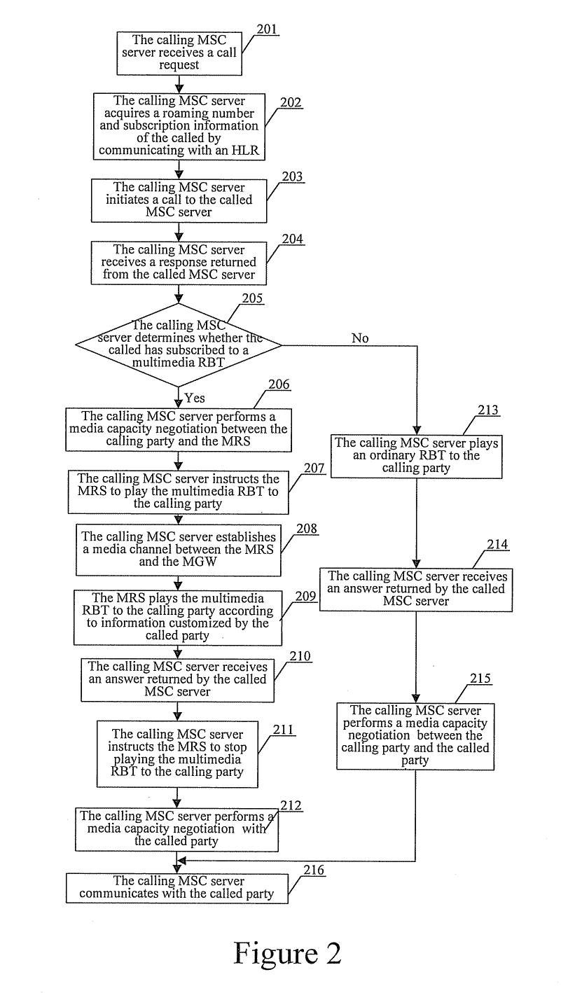

FIG. 2 is a flowchart illustrating a procedure for implementing a multimedia RBT service in accordance with an embodiment of the present invention. As shown in FIG. 2, the process for implementing a multimedia RBT service includes the following process.

Block 201-202: Upon receipt of a call initiated by a calling party to a called party, a calling MSC server acquires a roaming number and subscription information of the called party by communicating with an HLR.

The process of acquiring the roaming number by the calling MSC server by communicating with the HLR includes: the calling MSC server requests the HLR to provide the roaming number of the called party, and provides the HLR with the called number. Upon receipt of the request of the calling MSC server, the HLR requests a called MSC server to provide the roaming number according to the called number. Upon receipt of the request of the HLR, the called MSC server provides the HLR with the roaming number. Upon receipt of the roaming number, the HLR provides the calling MSC server with the roaming number. Since the subscription information of the called party is stored in the HLR, the HLR may provide the calling MSC server with the subscription information stored in the HLR.

Block 203-204: Upon receipt of the roaming number and the subscription information of the called party, the calling MSC server initiates a call to the called MSC server according to the roaming number. Upon receipt of the call, the called MSC server initiates paging to the called party, and returns a response to the calling MSC server when determining that the called party is currently in an idle state.

Block 205: Upon receipt of the response, the calling MSC server determines whether the called party has subscribed to a multimedia RBT service; if the called party has subscribed to the multimedia RBT service, performs Block 206; otherwise, performs Block 213.

206: The calling MSC server performs a media capability negotiation between the calling party and an MRS, and the process of the media capability negotiation includes: the calling MSC server performs a media capability negotiation with the calling party, and then performs a media capability negotiation with the MRS according to the result of the media capability negotiation with the calling party; or the calling MSC server first performs a media capability negotiation with the MRS, and then performs a media capability negotiation with the calling party according to the result of the media capability negotiation with the MRS.

207: The calling MSC server routes a message to the MRS according to the configured MRS address information to instruct the MRS to play a multimedia RBT to the calling party, and provides the MRS with the called number.

208: Upon receipt of the notification, the MRS establishes a media channel between the MRS and the MGW so that the MRS may play the multimedia RBT to the calling party via the MGW.

209: After having established the media channel, the MRS finds the multimedia RBT customized by the called party according to the called number, i.e., finds the multimedia RBT corresponding to the called number, and then plays to the calling party the multimedia RBT customized by the called party according to the result of the media capability negotiation.

The multimedia RBT customized by the called party may be the multimedia RBT corresponding to the called number, or may also be the multimedia RBT corresponding to the combination of the called number and the calling number to implement different multimedia RBTs customized by the called party for the different calling parties. In this way, when the called party customizes different multimedia RBTs for the different calling parties, the calling MSC server may further provide the MRS with the calling number in Block 207, and the MRS may find, according to the called number and the calling number in Block 209, the multimedia RBT corresponding to the calling party customized by the called party, i.e. the multimedia RBT corresponding to the combination of the called number and the calling number, thus playing different multimedia RBTs to the different calling parties as subscribed by the called party with better diversified implementation of the multimedia RBT service.

The above process of playing multimedia RBT by the MRS to the calling party refers to that the result of media capability negotiation supports the multimedia RBT; if the result of media capability negotiation does not support the multimedia RBT, MRS may play to the calling party an audio RBT which may be either as customized by the called party or as selected randomly for the calling party by the MRS.

Block 210: Upon receipt of the answer given by the called party, the called MSC server returns an answer to the calling MSC server to notify the calling MSC server that the called party has given an answer.

Block 211: Upon detecting the notification that the called MSC server answers the call, the calling MSC server instructs the MRS to stop playing the multimedia RBT to the calling party, and controls the MGW to release the media channel between the MGW and the MRS. Upon receipt of the instruction, the MRS stops playing the multimedia RBT to the calling party, and release the media channel between the MGW and the MRS.

Block 212: The calling MSC server performs a media capability negotiation with the called party, and then performs Block 216. If the calling party does not support a second media capability negotiation, the process of performing a media capability negotiation by the calling MSC server with the called party includes: the calling MSC server performs a media capability negotiation with the called party via the called MSC server according to the result of the media capability negotiation with the calling party in Block 205, thus normally communicating with the called party without the need for the calling party to conduct the second media capability negotiation. If the calling party is not consistent with the called party in the media capability upon the media capability negotiation, the calling MSC server may control the MGW to make a media format conversion so as to ensure the normal communication between the calling party and the called party.

Block 213-215: The calling MSC server plays a monotonous ordinary RBT such as beeps, to the calling party, and upon receipt of the answer returned by the called MSC server, the calling MSC server performs a media capability negotiation between the calling party and the called party. The media capability negotiation specifically includes: the calling MSC server first performs a media capability negotiation with the calling party and then, according to the result of the media capability negotiation with the calling party, performs a media capability negotiation with the called party; or the calling MSC server first performs a media capability negotiation with the called party and then, according to the result of the media capability negotiation with the called party, performs a media capability negotiation with the calling party.

Block 216: The calling party communicates with the called party according to the result of the media capability negotiation.

In addition, upon receipt of the answer returned by the called MSC server, the calling MSC server also may first perform Block 212, and then perform Block 211. That's to say the calling MSC server first performs a media capability negotiation with the called party, controls the MGW to remove the media channel between the MGW and the MRS upon the media capability negotiation with the called party, and then performs Block 216. When the calling party communicates with the called party, the calling MSC server instructs the MRS to stop playing the multimedia RBT, and upon receipt of the answer, the MRS stops playing the multimedia RBT to the calling party and releases the media channel between the MRS and the MGW. Upon receipt of the answer returned by the called MSC server, the calling MSC server may also perform Blocks 211 and 212 simultaneously, i.e., the calling MSC server performs a media capability negotiation with the calling party while instructs the MRS to stop playing the multimedia RBT to the calling party, and controls the MGW to remove the media channel between the MGW and the MRS. Upon detecting the notification, the MRS stops playing the multimedia RBT to the calling party, and releases the media channel. Upon the media capability negotiation with the called party, the calling party communicates with the called party.

If a traditional audio RBT service is still kept in the network, after a multimedia RBT service is supplemented in the network, there will be both the audio RBT service and the multimedia RBT service in the network. If a server for playing the audio RBT to the calling party is a different device from an MRS, i.e., the MRS plays a multimedia RBT to the calling party while an audio source server plays an audio RBT to the calling party, then when requesting the HLR to provide a roaming number, the HLR may first determine whether the called party has subscribed to an RBT service. If the called party has subscribed to the RBT service, the HLR continues to determine whether the called party has subscribed to an audio RBT service or a multimedia RBT service, and then the HLR provides the calling MSC server with the subscription information of the called party for indicating whether the called party has subscribed to the audio RBT service or the multimedia RBT service. If the called party has not subscribed to the RBT service, the HLR notifies the calling MSC server that the called party has not subscribed to the RBT service, and the calling MSC server plays an ordinary monotonous RBT, or beeps, to the calling party upon receipt of an answer given by the called MSC server.

When determining that it needs to play an RBT to the calling party, the calling MSC server, according to the subscription information of the called party provided by the HLR, determines whether the called party has subscribed to an audio RBT service or a multimedia RBT service; if the called party has subscribed to the audio RBT service, the calling MSC server routes a message to an audio source server for playing the audio RBT to the calling party, and instructs the audio source server to play an audio RBT to the calling party. If the called party has subscribed to the multimedia RBT service, the calling MSC server routes a message to the MRS, and instructs the MRS to play a multimedia RBT to the calling party.

If the server for playing an audio RBT to the calling party and an MRS can be implemented in a equipment for implementing an RBT, when a calling MSC server requests an HLR to provide a roaming number, after determining that the called party has subscribed to an RBT service, the HLR directly provides the calling MSC server with the subscription information of the called party, without determining whether the called party has subscribed to an audio RBT service or a multimedia RBT service. When determining that it needs to play an RBT to the calling party, the calling MSC server routes a message to the equipment for implementing the RBT, and instructs the equipment for implementing the RBT to play the RBT to the calling party. Because the RBT customized by the called party is stored in the equipment for implementing the RBT, the corresponding type of RBT may be played according to customization information, i.e., if the called party has subscribed to an audio RBT service, the equipment for implementing the RBT plays the audio RBT to the calling party; if the called party has subscribed to a multimedia RBT service, the equipment for implementing the RBT plays the multimedia RBT to the calling party.

If the server for playing an audio RBT to the calling party and an MRS are implemented in a equipment for implementing an RBT, the called party may also customize the RBTs of different types for the different callings, and when playing an RBT to the calling party, the equipment for implementing the RBT plays the RBT of the type corresponding to the calling party as customized by the called party. For example, the called party customizes audio RBT 1 for calling A, multimedia RBT 1 for calling B, multimedia RBT 2 for calling C, audio RBT 2 for calling D; if calling A calls the called party, the equipment for implementing an RBT plays audio RBT 1 to calling A; if calling B calls the called party, the equipment for implementing an RBT plays multimedia RBT 1 to calling B; if calling C calls the called party, the equipment for implementing an RBT plays multimedia RBT 2 to calling C; if calling D calls the called party, the equipment for implementing an RBT plays audio RBT 2 to calling D.

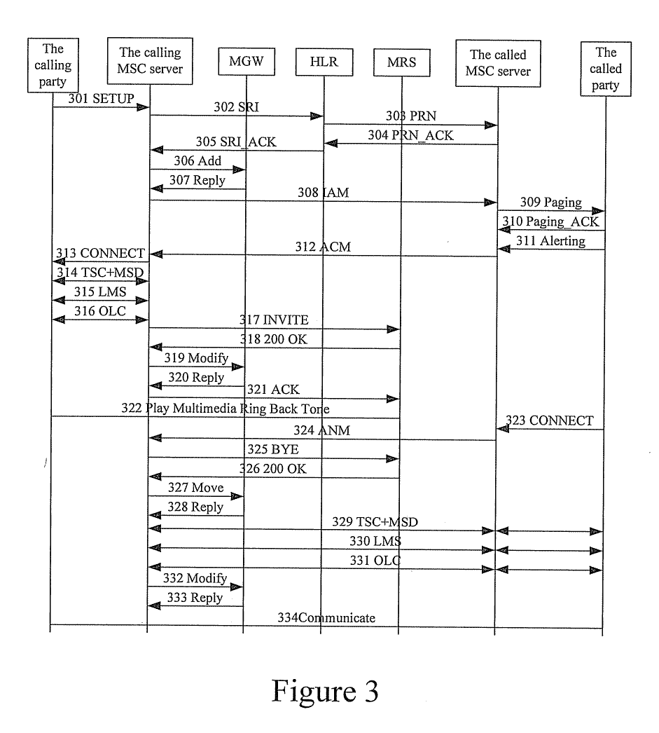

FIG. 3 is a flowchart illustrating message interaction for implementing a multimedia RBT service in accordance with still another embodiment of the present invention. As shown in FIG. 3, if a Session Initiation Protocol (SIP) is, for example, used between a calling MSC server and an MRS, the message interaction process for implementing a multimedia RBT service includes the following processes.

Processes 301-302: The calling party sends a call request, or SETUP, carrying both a called number and a calling number, to a calling MSC server. Upon receipt of the SETUP, the calling MSC server sends to an HLR a Send Routing Information (SRI) for acquiring a Mobile Station Roaming Number (MSRN) of the called party.

Process 303: Upon receipt of the SRI, the HLR sends to a called MSC server a Provide Roaming Number (PRN) to request the called MSC server to provide the MSRN of the called party. The called MSC server is an MSC server in which the called party is located currently.

Process 304: Upon receipt of the PRN, the called MSC server allocates the MSRN for the called party, and then returns to the HLR a Provide Roaming Number Acknowledgement (PRN_ACK) carrying the MSRN.

Process 305: Upon receipt of the PRN_ACK, the HLR returns to the called MSC server a Routing Acknowledgement (SRI_ACK) carrying both the MSRN and subscription information of the called party. The subscription information of the called party may be an identifier for identifying whether the called party has subscribed to a multimedia RBT service, e.g., indicating that the called party has subscribed to a multimedia RBT by 1, and has not subscribed to a multimedia RBT by 0.

Process 306: Upon receipt of the SRI_ACK, the called MSC server sends to the MGW an adding message, or Add, instructs the MGW to create a new Context, and instructs the MGW to reserve the Time Division Multiplex (TDM) end point, Real-Time Transport Protocol (RTP) end point and multiplexing end point to be used in the subsequent call process.

Process 307: Upon receipt of the Add, the MGW creates a new Context so as to use the Context to transmit call related medium stream in the subsequent call process, reserves the TDM end point, RTP end point and multiplexing end point to be used in the subsequent call process, and then returns to the calling MSC server a Reply to notify the calling MSC server that the Context has been created. The Reply contains the TDM end point, the RTP end point and the multiplexing end point reserved by the MGW.

Process 308: Upon receipt of the Reply, the calling MSC server, according to the roaming number acquired in Block 305, sends to the called MSC server an Initial Address Message (IAM), and initiates a call.

Process 309: Upon receipt of the IAM, the called MSC server sends to the called party a paging message, or Paging, to page the called party.

Processes 310-311: Upon receipt of the Paging, the called party in an idle state, sends to the called MSC server a Paging Acknowledgement (Paging-ACK), and sends to the called MSC server a signal message, or Alerting, to notify the called MSC server of the success of paging the called party.

Process 312: Upon receipt of the Paging-ACK and the Alerting, the called MSC server returns to the calling MSC server an Address Complete Message (ACM) to notify the calling MSC server of the success of paging the called party. The success of paging the called party refers to that the called party is currently in the idle state.

Process 313: Upon receipt of the ACM, the calling MSC server returns to the calling party a connection message, CONNECT, to set up a call.

Process 314-316: Upon receipt of the CONNECT, the calling party may adopt the H.245 protocol to perform a media capability negotiation with the calling MSC server, communicate a self-supported capability set with the calling MSC server via a Terminal Capability Set (TCS) message and select the media capability information used in the call process. The calling party may also male a master/slave determination with the calling MSC server via a Master Slave Determination (MSD) message, and thus determine the control relationship of media channel in the call process. MUXTAB information between the calling party and the calling MSC server is exchanged via a Local MUXTAB Send (LMS) message. And at last the media channel is established via an Open Logical Channel (OLC) message. Thus, the calling party completes the media capability negotiation with the calling MSC server and puts the network through.

Process 317: After successfully completing the media capability negotiation with the calling MSC server, according to the subscription information of the called party provided by the HLR in Process 305, the calling party determines that the called party has subscribed to a multimedia RBT service, and sends to the MRS an INVITE message to request the MRS to set up the call. The INVITE message, via the Session Description Protocol (SDP), carries the media capability information obtained by negotiating with the calling party, and carries the RTP end point in the MGW for media communication, i.e., RTP address and port. The RTP end point is the RTP end point acquired by the calling MSC server in Process 307. The INVITE message also carries the called number.

Process 318: Upon receipt of the INVITE message, the MRS selects media capability information according to the media capability information obtained by the negotiation between the calling MSC server and the calling party, returns to the calling MSC server a 200 OK acknowledgement, and puts the media channel between the MRS and the MGW through. The 200 OK acknowledgement carries the media capability information selected by the MRS, and carries the RTP end point in the MRS for media communication, i.e., RTP address and port.

In the above description, Processes 313-316 and precede Processes 317-318, i.e., the calling MSC server first performs a media capability negotiation with the calling party, and then, according to the result of the media capability negotiation with the calling party, performs a media capability negotiation with the MRS. As alternative way, Processes 317-318 may precede Processes 313-316, i.e., the calling MSC server first performs a media capability negotiation with the MRS, and then, according to the result of the media capability negotiation with the MRS, performs a media capability negotiation with the calling party.

Process 319: Upon receipt of the 200 OK acknowledgement, the calling MSC server sends to the MGW a modifying message, or Modify, carrying the media capability information, to request the MGW to modify the relevant information in the Context according to the result of the media capability negotiation between the calling MSC server and the MRS.

Process 320: Upon receipt of the Modify, the MGW modifies the relevant information in the Context as established in Process 307, e.g., the media capability information, puts the media channel between the MGW and the MRS through, and returns a Reply to the calling MSC server to notify the calling MSC server that the relevant information in the Context has been modified.

Process 321: Upon receipt of the Reply, the calling MSC server sends an ACK to the MRS to instruct the MRS to play the multimedia RBT to the calling party.

The above has described in detail the process of performing a media capability negotiation between the calling party and the MRS by the calling MSC server. However, the skilled in the art should know that it is only exemplary, and is not use to limit the scope of the invention. Alternatively, the media capability negotiation between the calling party and the MRS may also be performed by the called MSC server. Such a modification would be well known by the skilled in the art, so will give no detailed description here.

In the above process of performing Processes 317-318, the INVETE message, via the Session Description Protocol (SDP), carries the media capability information resulting from the media capability negotiation between the calling MSC server and the calling party, so that the MRS may select media capability information according to the media capability information provided by the calling MSC server, and carry the selected media capability information in the 200 OK acknowledgement returned to the calling MSC server. In addition, the INVETE message may not carry the media capability information resulting from the media capability negotiation between the calling MSC server and the calling party, and the MRS directly carries the media capability information of that MRS via the SDP in the 200 OK acknowledgement to be returned to the calling MSC server. The calling MSC server carries, in the ACK sent to MRS in Process 321, the media capability information selected according to the media capability information provided by the MRS.

Process 322: Upon receipt of the ACK, the MRS queries for the multimedia RBT corresponding to the called number, and then plays the multimedia RBT customized by the called party to the calling party according to the result of the media capability negotiation.

The calling MSC server may, in Process 317, further provide the MRS with the calling number, i.e., the calling number may further be carried in the INVITE message in Process 317. Thus in Process 322, the MRS queries for the multimedia RBT corresponding to the called number and the calling number to play different multimedia RBTs to the different callings as customized by the called party.

Processes 323-324: The called party gives an answer. The called party sends a CONNECT to the called MSC server, and the called MSC server sends an Answer Message (ANM) to notify the calling MSC server that the called party has given an answer, upon receipt of the CONNECT.

Processes 325-326: Upon receipt of the ANM, the calling MSC server sends a BYE message to the MRS to instruct the MRS to stop playing the multimedia RBT to the calling party. Upon receipt of the BYE, the MRS stops playing the multimedia RBT to the calling party, releases the media channel between the MRS and the MGW, and sends a 200 OK acknowledgement to the calling MSC server.

Processes 327-328: Upon receipt of the 200 OK acknowledgement, the calling MSC server sends a Move message to the MGW to instruct the MGW to release the media channel between the MGW and the MRS. Upon receipt of the Move message, the MGW removes the media channel between the MGW and the MRS, and returns a Reply to the calling MSC server.

Processes 329-331: Upon receipt of the Reply from the MGW, the calling MSC server may, using the H.245 protocol, performs a media capability negotiation with the called party via the called MSC server. The calling MSC server communicates with the called party for a self-supported capability set and selects the media capability information used in the call process, i.e., performs the media capability negotiation with the called party according to the result of the media capability negotiation with the calling party in Processes 314-316. The calling MSC server makes, with the called party, a master/slave determination via an MSD to determine the control relationship of the media channel in the call process. The calling MSC server exchanges MUXTAB information between the calling MSC server and the called party. At last the calling MSC server establishes the media channel via an OLC. And thus the calling MSC server completes the media capability negotiation with the called party, and puts the network through. If the calling party is not consistent with the called party in the media capability upon the media capability negotiation, the calling MSC server may control the MGW to make a media format conversion so as to ensure the normal communication between the calling party and the called party.

Upon receipt of the ANM sent by the called MSC server, the calling MSC server also may first perform Processes 327-331, then performs Processes 332-334, and finally performs Processes 325-326 during the communication between the calling party and the called party. Or alternatively, performs Processes 325-326 and Processes 327-331, and after that performs Processes 332-334.

Process 332: After successfully completing the media capability negotiation with the called party, the calling MSC server sends a Modify to the MGW, in which media capability information is carried, to request the MGW to modify the relevant information in the Context according to the result of the media capability negotiation between the calling MSC server and the called party.

Process 333: Upon receipt of the Modify, the MGW modifies the relevant information in the Context as established in Process 307, e.g., the media capability information, and returns a Reply to the calling MSC server to notify the calling MSC server that the relevant information in the Context has been modified.

Process 334: The calling party communicates with the called party according to the result of the media capability negotiation.

During the above message interaction, the SIP is used for the information interaction between the calling MSC server and MRS. Alternatively, other protocols besides the SIP, e.g., the H.245 protocol, the H.323 protocol, the MGCP, etc., may be used for the information interaction between the calling MSC server and the MRS. The protocol given in the embodiments of the invention is not limited in any way.

It can be seen from the above description that even though the called party who has subscribed to a multimedia RBT service is a user in the 2G network, as long as the calling party initiating a call to the called party, who is a user in the 3G network, a multimedia RBT service may still be implemented and the calling party may receive the multimedia RBT played to the calling party.

It should be emphasized that the above-described embodiments, particularly, any ‘preferred’ embodiments, are merely possible examples of implementations, merely set forth for a clear understanding of the principles of the invention. Many variations and modifications may be made to the above-described preferred embodiments without departing substantially from the spirit and principles of the invention. All such modifications and variations are intended to be included herein within the scope of this disclosure and the above-described preferred embodiments and protected by the following claims.

What is claimed is:

1. A method for implementing a multimedia Ring Back Tone (RBT) Service, comprising:
receiving a call request from a calling party;
performing a first media capability negotiation between the calling party and a Media Resource Server (MRS) after detecting a response of a called party; and
instructing the MRS to play a multimedia RBT to the calling party according to a result of the first media capability negotiation.

2. The method of claim 1, further comprising:
determining, by a calling Mobile Switching Center (MSC) server, that the called party has subscribed to a multimedia RBT service according to subscription information of the called party.

3. The method of claim 2, wherein:
the subscription information of the called party is stored in a Home Location Register (HLR); and
the process of determining that the called party has subscribed to the multimedia RBT service comprises:
determining, by the HLR, that the called party has subscribed to an audio RBT service or the multimedia RBT service after determining that the called party has subscribed to a RBT service;
sending to the calling MSC server the subscription information indicating whether the called party has subscribed to the audio RBT service or the multimedia RBT service; and
determining, by the calling MSC server, that the called party has subscribed to the multimedia RBT service according to the subscription information provided by the HLR.

4. The method of claim 2, wherein the subscription information of the called party is stored in an HLR, the method further comprising:
providing, by the HLR, the subscription information of the called party for the calling MSC server after determining that the called party has subscribed to an RBT service;
instructing the MRS to play an audio RBT to the calling party according to the subscription information of the called party.

5. The method of claim 1, wherein the process of playing the multimedia RBT to the calling party comprises:
playing the multimedia RBT customized by the called party to the calling party.

6. The method of claim 5, further comprising:
providing a calling number for the MRS, wherein
the process of playing the multimedia RBT customized by the called party to the calling party comprises:
playing the multimedia RBT corresponding to the called number.

7. The method of claim 5, further comprising:
providing a calling number and a called number for the MRS, wherein
the process of playing the multimedia RBT customized by the called party to the calling party comprises:
playing the multimedia RBT corresponding to a combination of the called number and the calling number.

8. The method of claim 5, wherein the process of playing multimedia RBT according to the result of the first media capability negotiation comprises:
determining, by the MRS, whether the result of the first media capability negotiation supports a multimedia format;
playing the multimedia RBT if the result of first media capability negotiation supports the multimedia format; and
playing an audio RBT if the result of the first media capability negotiation does not support the multimedia format.

9. The method of claim 1, further comprising:
detecting a notification that the called party answers the call,
instructing the MRS to stop playing the multimedia RBT to the calling party,
performing a second media capability negotiation between the calling party and the called party, and
communicating between the calling party and the called party according to a result of second media capability negotiation.

10. The method of claim 9, wherein the process of performing the second media capability negotiation between the calling party and the called party comprises:
performing the second media capability negotiation with the called party according to the result of the first media capability negotiation.

11. The method of claim 1, further comprising:
detecting a notification that the called party answers the call,
performing a second media capability negotiation between the calling party and the called party,
communicating between the calling party and the called party according to a result of second media capability negotiation, and
stopping, by the MRS, playing the multimedia RBT to the calling party.

12. The method of claim 11, wherein the process of performing the second media capability negotiation between the calling party and the called party comprises:
performing the second media capability negotiation with the called party according to the result of the first media capability negotiation.

13. The method of claim 1, further comprising:
detecting a notification that the called party answers the call,
instructing the MRS to stop playing the multimedia RBT to the calling party;
performing a second media capability negotiation between the calling party and the called party simultaneously, and
communicating between the calling party and the called party according to a result of second media capability negotiation.

14. The method of claim 13, wherein the process of performing the second media capability negotiation between the calling party and the called party comprises:
performing the second media capability negotiation with the called party according to the result of the first media capability negotiation.

15. The method of claim 1, wherein the process of performing the media capability negotiation between the calling party and the MRS is controlled by a calling MSC server or a called MSC server.

16. A system for implementing a multimedia Ring Back Tone (RBT) service, comprising:
a Mobile Switching Center (MSC) server and a Media Resource Server (MRS); wherein:
the MSC server is capable of performing a media capability negotiation between a calling party and the MRS according to a call request from the calling party, and instructing the MRS to play a multimedia RBT to the calling party according to a result of the first media capability negotiation; and
the MRS is capable of storing a multimedia RBT, and performing the media capability negotiation with the MSC server, and playing the multimedia RBT to the calling party according to the result of the first media capability negotiation.

17. The system of claim 16, further comprising:
a Home Location Register (HLR), capable of providing subscription information of a called party for the MSC server; wherein:
the MSC server is further capable of determining that the called party has subscribed to a multimedia RBT service according to the subscription information of the called party provided by the HLR.

18. The system of claim 16, further comprising:
a Home Location Register (HLR), capable of storing subscription information of a called party, determining that the called party has subscribed to a multimedia RBT service, and providing the calling MSC server with information indicating that the called party has subscribed to the multimedia RBT service.

19. The system of claim 16, further comprising:
a Home Location Register (HLR), capable of storing subscription information of a called party, and providing the MSC server with subscription information of the called party upon determining that the called party has subscribed to an RBT service; wherein:
the MSC server is further capable of sending a notification for playing an RBT to the calling party; and
the MRS is further capable of playing an audio RBT as the RBT customized by the called party is the audio RBT.

20. The system of claim 16, further comprising:
an audio resource server, capable of storing an audio RBT, and playing the audio RBT to the calling party when the called party does not subscribe the multimedia RBT.

21. A Media Resource Server (MRS), comprising:
a component, configured to:
store a multimedia Ring Back Tone (RBT);
perform a media capability negotiation with a Mobile Switching Center (MSC) server;
play a multimedia RBT according to a result of media capability negotiation for the calling party.

22. A Mobile Switching Center (MSC) server, comprising:
a component, configured to:
perform a media capability negotiation with a Media Resource Server (MRS);
perform a media capability negotiation with a subscriber;
instruct the MRS to play a multimedia Ring Back Tone (RBT) according to the media capability negotiation.

23. The MSC server of claim 22, wherein the component is further configured to determine that a subscriber has subscribed to a multimedia RBT service before performing a media capability negotiation.

24. The MSC server of claim 22, wherein
the component is further configured to instruct the MRS to stop playing the multimedia RBT after a called party answers a call.
